(19) United States
(12) Patent Application Publication
(10) Pub. No.: US 2023/0357041 A1
(43) Pub. Date: Nov. 9, 2023

(54) SURFACE-TREATED ZIRCONIA NANOPOWDER, AND ZIRCONIA DISPERSION AND USE THEREOF

(71) Applicant: SHANDONG SINOCERA FUNCTIONAL MATERIAL CO., LTD., Dongying (CN)

(72) Inventors: Xibin SONG, Dongying (CN); Haiyang MA, Dongying (CN); Liaodong AI, Dongying (CN); Hongliang XI, Dongying (CN)

(21) Appl. No.: 18/332,803

(22) Filed: Jun. 12, 2023

Related U.S. Application Data
(63) Continuation-in-part of application No. PCT/CN2022/119078, filed on Sep. 15, 2022.

(30) Foreign Application Priority Data
May 6, 2022 (CN) 202210485112.5

(51) Int. Cl. C01G 25/02; C08K 9/04; C08K 3/22

(52) U.S. Cl. CPC C01G 25/02; C08K 9/04; C08K 3/22; C08K 2003/2244; C01P 2004/64; C08K 2201/011

(57) ABSTRACT

The present disclosure provides a surface-treated zirconia nanopowder, and a zirconia dispersion and use thereof, and relates to the technical field of optical resin. A surface of the surface-treated zirconia powder contains a surface treatment agent; and the surface treatment agent has an R-Y structure, wherein group R includes a large steric hindrance group, and group Y includes a group capable of interacting with zirconia. The surface treatment agent is used to introduce a large steric hindrance group to a zirconia surface, and the agglomeration of zirconia particles is inhibited through a steric hindrance effect of the large steric hindrance group, so that the surface-treated zirconia powder has a good dispersibility and a good agglomeration inhibition effect.

### CROSS-REFERENCE TO RELATED APPLICATION

The present disclosure is a continuation-in-part application of International Application No. PCT/CN2022/119078, filed Sep. 15, 2022 and also claims priority to CN 202210485112.5, filed May 6, 2022, entire contents of which are incorporated herein by reference.

### TECHNICAL FIELD

The present disclosure relates to the technical field of optical resin, and in particular to a surface-treated zirconia nanopowder, and a zirconia dispersion (i.e., dispersion liquid) and use thereof.

### BACKGROUND

Zirconia nanoparticles have a high refractive index and can be used in organic matrices to alter the optical properties of the matrices. For example, zirconia dispersions prepared from zirconia nanoparticles have been used to increase the refractive index of an organic matrix while maintaining light transmission. The refractive index of the zirconia dispersion depends on a loading percentage of zirconia in the dispersion and the characteristics of zirconia particles, wherein the degree of association between primary particles is one of the most important parameters affecting the performance of the zirconia dispersion, and after the particles are agglomerated (associated), the improvement of performance such as the refractive index and the light transmittance of the zirconia dispersion will be adversely affected.

Surface modification of zirconia nanoparticles can be used to prevent or reduce nanoparticle agglomeration and to enhance the stability of the nanoparticles within organic matrices. Although some surface-modified zirconia dispersions have been successfully prepared at present, most of them have disadvantages such as poor agglomeration inhibition effect and poor stability, such that effects are affected when the dispersions are applied to downstream display fields. When an organic solvent dispersion of zirconia is prepared, in order to prevent the occurrence of particle agglomeration, the organic solvent dispersion of zirconia is mostly prepared via liquid phase methods (for example, solvent phase change or ultrafiltration), which are cumbersome, have difficulties in transporting liquid substances and have a high cost, while the problem of powder agglomeration cannot be overcome by a method for redissolving the powders in the solvent.

In view of this, the present disclosure is set forth.

### SUMMARY

The objectives of the present disclosure include providing a surface-treated zirconia powder to solve the technical problems of high agglomeration degree, poor stability and poor dispersibility of zirconia powders in the prior art.

In order to achieve at least one of the above technical objectives of the present disclosure, the following technical solutions are particularly adopted.

The present disclosure provides a surface-treated zirconia powder, wherein a surface of the zirconia powder contains a surface treatment agent; and

the surface treatment agent has an R-Y structure,

wherein group R comprises a large steric hindrance group, and group Y comprises a group capable of interacting with zirconia.

The present disclosure further provides a preparation method for the surface-treated zirconia powder, wherein the preparation method comprises adding a surface treatment agent to a zirconia solution for reaction, and removing a solvent after completion of the reaction to obtain the surface-treated zirconia powder.

The present disclosure further provides a zirconia dispersion comprising the surface-treated zirconia powder.

The present disclosure further provides use of the zirconia dispersion in preparing an optical film.

### DETAILED DESCRIPTION

The technical solutions in the examples of the present disclosure will be clearly and completely described below. Apparently, the described examples are merely a part, rather than all of the examples of the present disclosure. The detailed description of the embodiments and examples of the present disclosure is not intended to limit the scope of the present disclosure as claimed, but is merely representative of selected examples of the present disclosure. Based on the examples of the present disclosure, all other examples obtained by those skilled in the art without creative efforts fall within the protection scope of the present disclosure.

If reaction conditions are not specified in the examples, conventional conditions or conditions recommended by the manufacturers shall be adopted. Reagents or instruments without specified manufacturers used herein are conventional products that are commercially available.

A nanosized powder has a small size and a large specific surface, so that the powder system has very high surface energy, and becomes a thermodynamically unstable system. In order to reduce the surface energy in the system, primary particles of the nanopowder will aggregate together to form secondary particles, which is referred to as agglomeration. The particle size of the primary particles is a primary particle size, and the particle size of the secondary particles is a secondary particle size.

A surface-treated zirconia powder provided according to the present disclosure, wherein a surface of the zirconia powder contains a surface treatment agent; and

the surface treatment agent has an R-Y structure,

wherein group R comprises a large steric hindrance group, and group Y comprises a group capable of interacting with zirconia.

According to the surface-treated zirconia powder provided by the present disclosure, the surface treatment agent is used to introduce a large steric hindrance group to a zirconia surface, and the agglomeration of zirconia particles is inhibited through a steric hindrance effect of the large steric hindrance group, so that the surface-treated zirconia powder has a good dispersibility and a good agglomeration inhibition effect.

In some embodiments of the present disclosure, the large steric hindrance group comprises at least one of a substituted or unsubstituted benzene ring, a substituted or unsubstituted naphthalene ring, a substituted or unsubstituted cycloalkane, isopropyl, tert-butyl and isobutyl.

The substituted or unsubstituted benzene ring comprises ortho, meta or para substitution on the benzene ring, and can also be one-membered substituted, two-membered substituted or three-membered substituted, and the substituents are selected from at least one of halogen, nitro, cyano, hydroxyl, amino, C1-C10 alkyl, C1-C10 alkoxy or acryloyloxy.

In the substituted or unsubstituted naphthalene ring, the substituents are selected from at least one of hydroxyl, alkyl, alkoxy, branched alkyl, cycloalkyl, cyano, nitro, methoxy, benzoyl, phenoxy or phenoxymethyl.

The substituted or unsubstituted cycloalkane can be a 3-12-membered ring, and the substituents on the ring can be selected from at least one of halogen, nitro, cyano, hydroxyl, amino, C1-C10 alkyl or C1-C10 alkoxy.

In some embodiments of the present disclosure, the group capable of interacting with zirconia comprises at least one of carboxyl, hydroxyl, alkyl, alkoxy, epoxy, carbonyl, amino, hydrogen and halogen.

In some embodiments of the present disclosure, the group capable of reacting with hydroxyl is typically, but not limited to, carboxyl, hydroxyl, alkyl, alkoxy, epoxy, carbonyl, amino, hydrogen or halogen.

A preparation method for the surface-treated zirconia powder provided according to the present disclosure, wherein the preparation method comprises adding a surface treatment agent to a zirconia solution for reaction, and removing a solvent after completion of the reaction to obtain the surface-treated zirconia powder.

The preparation method for the surface-treated zirconia powder provided by the present disclosure has a simple process and is suitable for large-scale industrial production.

In some embodiments of the present disclosure, the surface treatment agent is added in an amount of 3% to 20% by mass of the zirconia.

When the addition amount of the surface treatment agent is less than 3%, the surface treatment effect is poor; and when the addition amount of the surface treatment agent is more than 20%, the cost is increased, which is unfavorable for industrial production.

In some embodiments of the present disclosure, the surface treatment agent is added in an amount which is typically, but not limited to, 3%, 5%, 7%, 9%, 11%, 13%, 15%, 17%, 19% or 20% by mass of the zirconia.

In some embodiments of the present disclosure, the zirconia solution is obtained by mixing an aqueous zirconia solution with an organic solvent.

In some embodiments of the present disclosure, the organic solvent comprises propylene glycol monoethyl ether.

Propylene glycol monoethyl ether is an organic compound with a chemical formula of C₅H₁₂O₂. It is cheap and easily available, and is miscible with water, which is beneficial to the surface treatment reaction.

In some embodiments of the present disclosure, the mixing is performed at a mass ratio of 1:0.5-2, optionally 1:1.

In some embodiments of the present disclosure, the mixing is performed at a mass ratio of the aqueous zirconia solution to the organic solvent which is typically, but not limited to, 1:0.5, 1:1, 1:1.5 or 1:2.

In some embodiments of the present disclosure, a method for removing the solvent comprises lyophilization.

Lyophilization is used to remove the solvent from the surface-treated zirconia powder, wherein solid ice is formed in the process of lyophilization and prevents the particles from being re-aggregated, and after the ice is sublimated, the particles will not be excessively close to each other due to the lack of surface tension of water, thus particle agglomeration is effectively avoided.

A zirconia dispersion provided according to the present disclosure, comprising the surface-treated zirconia powder.

The zirconia dispersion provided by the present disclosure is obtained by redissolving the prepared surface-treated zirconia powder, wherein the particle agglomeration degree of the zirconia dispersion is 0.2-3, the rate of change in refractive index is less than 1% after the dispersion is left to stand for 12 months at room temperature without any light, and the dispersion has a uniform dispersibility, a high stability, a good redissolution effect and a small agglomeration degree.

In some embodiments of the present disclosure, the surface-treated zirconia powder has a content of 50 wt. % to 75 wt. %.

In some embodiments of the present disclosure, the surface-treated zirconia powder in the zirconia dispersion has a content which is typically, but not limited to, 50 wt. %, 55 wt. %, 60 wt. %, 65 wt. %, 70 wt. % or 75 wt. %.

In some embodiments of the present disclosure, the solvent of the zirconia dispersion comprises an organic solvent.

In some embodiments of the present disclosure, the organic solvent comprises at least one of an alcohol organic solvent, a ketone organic solvent, an ester organic solvent, an ether organic solvent, an aromatic hydrocarbon organic solvent, a halogenated hydrocarbon organic solvent and a naphthenic hydrocarbon organic solvent.

In some embodiments of the present disclosure, the ketone organic solvent comprises butanone.

In some embodiments of the present disclosure, the zirconia dispersion further comprises an agglomeration inhibitor.

The agglomeration inhibitor is coated on the surfaces of the zirconia particles after being added to the zirconia dispersion, and functions in cooperation with the surface treatment agent, thereby maximally inhibiting the agglomeration of the particles.

In some embodiments of the present disclosure, the agglomeration inhibitor comprises at least one of SU235, SU241, SU912, SU920 and SU983.

It should be noted that SU235, SU241, SU912, SU920 and SU983 are all known inhibitor brands in the art.

In some embodiments of the present disclosure, the agglomeration inhibitor is typically, but not limited to, SU235, SU241, SU912, SU920 or SU983.

The agglomeration inhibitors mentioned above have larger steric hindrances and more branched chains, and have a good inhibition effect on the agglomeration of particles.

Use of the zirconia dispersion provided according to the present disclosure in preparing an optical film.

The use of the zirconia dispersion provided by the present disclosure in preparing the optical film provides a dispersion with a good stability for the optical film. The prepared optical film has a good uniformity, the refractive index of the optical film is greatly increased, and the performance of the film is improved.

The following examples are given to illustrate the present disclosure, but the present disclosure is not limited to these examples in any way. If reaction conditions for raw materials used in the examples and the comparative examples are not specified, conventional conditions or conditions recommended by the manufacturers shall be adopted.

### Example 1

This example provided a surface-treated zirconia powder, and the preparation method specifically included the following steps:
1. preparing a 25 wt. % aqueous solution with nano zirconia, and adding propylene glycol monoethyl ether at a volume ratio of 1:1 into the aqueous solution to obtain a zirconia solution;
2. adding 4-tert-butylcyclohexyl acetic acid to the zirconia solution for surface treatment, with the 4-tert-butylcyclohexyl acetic acid being added in an amount of 12% by mass of the zirconia; and
3. performing lyophilization at a temperature of −18° C. for 30 min after the surface treatment was completed to obtain the surface-treated zirconia powder.

### Example 2

This example provided a surface-treated zirconia powder, and differed from Example 1 in that the 4-tert-butylcyclohexyl acetic acid was added in an amount of 3% by mass of the zirconia in the step 2. All the remaining raw materials and steps were the same as those in Example 1 and are not described in detail here.

### Example 3

This example provided a surface-treated zirconia powder, and differed from Example 1 in that the 4-tert-butylcyclohexyl acetic acid was added in an amount of 20% by mass of the zirconia in the step 2. All the remaining raw materials and steps were the same as those in Example 1 and are not described in detail here.

### Example 4

This example provided a surface-treated zirconia powder, and differed from Example 1 in that the 4-tert-butylcyclohexyl acetic acid was added in an amount of 30% by mass of the zirconia in the step 2. All the remaining raw materials and steps were the same as those in Example 1 and are not described in detail here.

### Example 5

This example provided a surface-treated zirconia powder, and differed from Example 1 in that the surface treatment agent in the step 2 was tert-butyl acetic acid. All the remaining raw materials and steps were the same as those in Example 1 and are not described in detail here.

### Example 6

This example provided a surface-treated zirconia powder, and differed from Example 1 in that the surface treatment agent in the step 2 was 4-(6-(acryloyloxy)hexyloxy)benzoic acid. All the remaining raw materials and steps were the same as those in Example 1 and are not described in detail here.

### Example 7

This example provided a surface-treated zirconia powder, and differed from Example 1 in that the surface treatment agent in the step 2 is adamantane acetic acid. All the remaining raw materials and steps were the same as those in Example 1 and are not described in detail here.

### Example 8

This example provided a zirconia dispersion, wherein an MEK type nano zirconia dispersion was obtained by dispersing the surface-treated zirconia powder obtained in Example 1 in methyl ethyl ketone (MEK) and adding an agglomeration inhibitor SU983 with the SU983 being added in an amount of 1% by mass of the zirconia.

### Example 9

This example provided a zirconia dispersion, and differed from Example 8 in that the SU983 was added in an amount of 5% by mass of the zirconia. All the remaining raw materials and steps were the same as those in Example 8 and are not described in detail here.

### Example 10

This example provided a zirconia dispersion, and differed from Example 8 in that the SU983 was added in an amount of 8% by mass of the zirconia. All the remaining raw materials and steps were the same as those in Example 8 and are not described in detail here.

### Example 11

This example provided a zirconia dispersion, and differed from Example 8 in that the SU983 was added in an amount of 20% by mass of the zirconia. All the remaining raw materials and steps were the same as those in Example 8 and are not described in detail here.

### Example 12

This example provided a zirconia dispersion, and differed from Example 9 in that the surface-treated zirconia powder provided by Example 5 was used. All the remaining raw materials and steps were the same as those in Example 9 and are not described in detail here.

### Example 13

This example provided a zirconia dispersion, and differed from Example 9 in that the surface-treated zirconia powder provided by Example 2 was used. All the remaining raw materials and steps were the same as those in Example 9 and are not described in detail here.

### Example 14

This example provided a zirconia dispersion, and differed from Example 9 in that the surface-treated zirconia powder provided by Example 3 was used. All the remaining raw materials and steps were the same as those in Example 9 and are not described in detail here.

### Example 15

This example provided a zirconia dispersion, and differed from Example 9 in that the surface-treated zirconia powder provided by Example 4 was used. All the remaining raw materials and steps were the same as those in Example 9 and are not described in detail here.

### Example 16

This example provided a zirconia dispersion, and differed from Example 9 in that the agglomeration inhibitor used was SU920. All the remaining raw materials and steps were the same as those in Example 9 and are not described in detail here.

### Example 17

This example provided a zirconia dispersion, and differed from Example 9 in that the agglomeration inhibitor used was SU912. All the remaining raw materials and steps were the same as those in Example 9 and are not described in detail here.

### Example 18

This example provided a zirconia dispersion, and differed from Example 9 in that the agglomeration inhibitor used was SU241. All the remaining raw materials and steps were the same as those in Example 9 and are not described in detail here.

### Example 19

This example provided a zirconia dispersion, and differed from Example 9 in that the agglomeration inhibitor used was SU235. All the remaining raw materials and steps were the same as those in Example 9 and are not described in detail here.

### Example 20

This example provided a zirconia dispersion, and differed from Example 9 in that no agglomeration inhibitor was used. All the remaining raw materials and steps were the same as those in Example 9 and are not described in detail here.

### Example 21

This example provided a zirconia dispersion, and differed from Example 9 in that the surface-treated zirconia powder provided by Example 6 was used. All the remaining raw materials and steps were the same as those in Example 9 and are not described in detail here.

### Example 22

This example provided a zirconia dispersion, and differed from Example 9 in that the surface-treated zirconia powder provided by Example 7 was used. All the remaining raw materials and steps were the same as those in Example 9 and are not described in detail here.

### Comparative Example 1

This comparative example provided a surface-treated zirconia powder, and differed from Example 1 in that the surface treatment agent was acetic acid. All the remaining raw materials and steps were the same as those in Example 1 and are not described in detail here.

### Comparative Example 2

This comparative example provided a zirconia powder, and differed from Example 1 in that no surface treatment agent was added. All the remaining raw materials and steps were the same as those in Example 1 and are not described in detail here.

### Comparative Example 3

This comparative example provided a zirconia dispersion, and differed from Example 9 in that the surface-treated zirconia powder provided by Comparative Example 1 was used. All the remaining raw materials and steps were the same as those in Example 9 and are not described in detail here.

### Comparative Example 4

This comparative example provided a zirconia dispersion, and differed from Example 9 in that the zirconia powder provided by Comparative Example 2 was used. All the remaining raw materials and steps were the same as those in Example 9 and are not described in detail here.

### Test Example

The zirconia dispersions obtained in Examples 8 to 22 and Comparative Examples 3 to 4 were subjected to measurements of particle agglomeration degree and refractive-index change.

The average particle size of the particles was measured using a Malvern 2000 Laser Particle Size Analyzer available from Malvern Instruments Limited (UK) according to the measuring method of GB/T19077.1-2003, wherein

particle agglomeration degree=(average secondary particle size of powder particles−average primary particle size of powder particles)/average primary particle size of powder particles Equation (1)

As can be seen from the above equation (1), when the particle agglomeration degree is 0, it means the average secondary particle size of powder particles is the same as the average primary particle size of powder particles, and also means the powders are not agglomerated, and the larger the value of the particle agglomeration degree is, the more severe the agglomeration of the powder particles is.

In the present disclosure, the average primary particle size of the zirconia particles is the average particle size of the particles in the aqueous zirconia solution, and the average secondary particle size of the zirconia particles is the average particle size of the particles in the organic MEK-type zirconia dispersion.

The refractive-index change was measured using an automatic refractometer A670 available from Hanon Instruments according to the measuring method of GB/T 614-2006.

The data obtained from the tests are shown in Table 1.

TABLE 1
Performance data table of zirconia dispersions

| | Particle | Rate of change in |
|---|---|---|
| | agglomeration | refractive index of |
| | degree | dispersion (%) |
| Example 8 | 2.3 | 0.51% |
| Example 9 | 0.2 | 0.12% |
| Example 10 | 0.8 | 0.19% |
| Example 11 | 3.8 | 1.21% |
| Example 12 | 0.7 | 0.16% |
| Example 13 | 2.6 | 0.66% |
| Example 14 | 1.2 | 0.43% |
| Example 15 | 4.2 | 1.27% |
| Example 16 | 0.5 | 0.16% |
| Example 17 | 0.9 | 0.22% |
| Example 18 | 1.4 | 0.28% |
| Example 19 | 1.7 | 0.42% |
| Example 20 | 5.1 | 1.49% |
| Example 21 | 3 | 1% |
| Example 22 | 1.8 | 0.36% |
| Comparative | 5.7 | 1.45% |
| Example 3 | | |
| Comparative | 6.5 | Precipitation |
| Example 4 | | |

As can be seen from Table 1, when Example 9 is compared with Comparative Example 3, in Comparative Example 3, acetic acid used as the surface treatment agent contains no large steric hindrance group, the particle agglomeration degree is 5.7, and the rate of change in refractive index of the MEK type dispersion is 1.45%, which shows that all the values are higher than the corresponding parameters in Example 9, indicating that the large steric hindrance group plays an important role in inhibiting particle agglomeration and maintaining the stability of a dispersion. In Example 20 and Comparative Example 4 in which no agglomeration inhibitor and no surface treatment agent are added, respectively, the particle agglomeration degrees and the rates of change in refractive index of the dispersions are inferior to those of Example 9, and in Comparative Example 4, the MEK type dispersion prepared even exhibits the phenomenon of zirconia precipitation, indicating that the surface treatment agent functions in cooperation with the agglomeration inhibitor in inhibiting particle agglomeration and maintaining the stability of a dispersion, and that the two components are both indispensable. In addition, the contents of the surface treatment agent and the agglomeration inhibitor have a large influence on the inhibition of particle agglomeration and on the preparation process of a dispersion, and the amounts thereof should be controlled within a reasonable range, or otherwise not only adverse effects will be caused, but also the cost will be increased, which is fully demonstrated in Examples 8 to 11 and 13 to 15. Meanwhile, in Examples 9, 12, 21 and 22, the difference in the types of the surface treatment agents results in a large difference in the particle agglomeration degrees and the rates of change in the refractive index of the MEK type dispersions, indicating that the difference in the structures of the large steric hindrance groups of different surface treatment agents results in a difference in the steric hindrance abilities thereof, and thus the effects of inhibiting particle agglomeration are also different. Similarly, in Examples 9 and 16 to 19, the difference in the types of the agglomeration inhibitors also results in a large difference in the particle agglomeration degrees and the rates of change in the refractive index of the MEK type dispersions, indicating that different agglomeration inhibitors have different abilities to inhibit particle agglomeration.

Although specific examples have been used to illustrate and describe the present disclosure, it should be appreciated that many other changes and modifications can be made without departing from the spirit and scope of the present disclosure. It is therefore intended to cover in the appended claims all such changes and modifications falling within the scope of the present disclosure.

### INDUSTRIAL APPLICABILITY

According to the surface-treated zirconia powder provided by the present disclosure, the surface treatment agent is used to introduce a large steric hindrance group to a zirconia surface, and the agglomeration of zirconia particles is inhibited through a steric hindrance effect of the large steric hindrance group, so that the surface-treated zirconia powder has a good dispersibility and a good agglomeration inhibition effect, and further, can be used in industrial preparation of a zirconia dispersion and an optical film.

What is claimed is:

1. A surface-treated zirconia powder, wherein a surface of the zirconia powder contains a surface treatment agent, and
the surface treatment agent has an R-Y structure,
wherein group R comprises a large steric hindrance group, and group Y comprises a group capable of interacting with zirconia.

2. The surface-treated zirconia powder according to claim 1, wherein the large steric hindrance group comprises at least one of a substituted or unsubstituted benzene ring, a substituted or unsubstituted naphthalene ring, a substituted or unsubstituted cycloalkane, isopropyl, tert-butyl and isobutyl.

3. The surface-treated zirconia powder according to claim 2, wherein the substituted or unsubstituted benzene ring comprises ortho, meta or para substitution on a benzene ring, and is one-membered substituted, two-membered substituted or three-membered substituted, and substituents are selected from at least one of halogen, nitro, cyano, hydroxyl, amino, C1-C10 alkyl, C1-C10 alkoxy or acryloyloxy; in the substituted or unsubstituted naphthalene ring, substituents are selected from at least one of hydroxyl, alkyl, alkoxy, branched alkyl, cycloalkyl, cyano, nitro, methoxy, benzoyl, phenoxy or phenoxymethyl; and the substituted or unsubstituted cycloalkane is a 3-12-membered ring, and substituents on a ring are selected from at least one of halogen, nitro, cyano, hydroxyl, amino, C1-C10 alkyl or C1-C10 alkoxy.

4. The surface-treated zirconia powder according to claim 1, wherein the group capable of interacting with zirconia comprises at least one of carboxyl, hydroxyl, alkyl, alkoxy, epoxy, carbonyl, amino, hydrogen and halogen.

5. A preparation method for the surface-treated zirconia powder according to claim 1, comprising adding a surface treatment agent to a zirconia solution for a reaction, and removing a solvent after completion of the reaction to obtain the surface-treated zirconia powder.

6. The preparation method according to claim 5, wherein the surface treatment agent is added in an amount of 3% to 20% by mass of zirconia.

7. The preparation method according to claim 5, wherein the zirconia solution is obtained by mixing an aqueous zirconia solution with an organic solvent.

8. The preparation method according to claim 7, wherein the organic solvent comprises propylene glycol monoethyl ether.

9. The preparation method according to claim 7, wherein the mixing is performed at a mass ratio of 1:0.5-2.

10. The preparation method according to claim 9, wherein the mixing is performed at a mass ratio of 1:1.

11. The preparation method according to claim 5, wherein a method for removing the solvent comprises lyophilization.

12. A zirconia dispersion, comprising the surface-treated zirconia powder according to claim 1.

13. The zirconia dispersion according to claim 12, wherein the surface-treated zirconia powder has a content of 50 wt. % to 75 wt. %.

14. The zirconia dispersion according to claim 12, wherein a solvent of the zirconia dispersion comprises an organic solvent.

15. The zirconia dispersion according to claim 14, wherein the organic solvent comprises at least one of an alcohol organic solvent, a ketone organic solvent, an ester organic solvent, an ether organic solvent, an aromatic hydrocarbon organic solvent, a halogenated hydrocarbon organic solvent and a naphthenic hydrocarbon organic solvent.

16. The zirconia dispersion according to claim 15, wherein the ketone organic solvent comprises butanone.

17. The zirconia dispersion according to claim 12, wherein the zirconia dispersion further comprises an agglomeration inhibitor.

18. The zirconia dispersion according to claim 17, wherein the agglomeration inhibitor comprises at least one of SU235, SU241, SU912, SU920 and SU983.
